(19) United States
(12) Patent Application Publication
(10) Pub. No.: US 2008/0021933 A1
(43) Pub. Date: Jan. 24, 2008

(54) Job processing system, job processing apparatus, job identifying method, and recording medium

(75) Inventor: Tomomi Ono, Akashi-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/822,849

(22) Filed: Jul. 10, 2007

(30) Foreign Application Priority Data
Jul. 21, 2006 (JP) 2006-200118

(51) Int. Cl. G06F 17/30

(52) U.S. Cl. 707/201; 707/E17.007

(57) ABSTRACT

A job processing system equipped with a portable terminal apparatus and a job processing apparatus, wherein the portable terminal apparatus comprises: a transmission history storage that stores a transmission history of a job transmitted to the job processing apparatus; and a transmitter that transmits the stored transmission history to the job processing apparatus, and wherein the job processing apparatus comprises: a job receiver that receives the job; a job storage that stores the received job; a receipt history storage that stores a receipt history of the received job; a transmission history receiver that receives the transmission history from the portable terminal apparatus; and a history collator that identifies a job corresponding to the transmission history of the portable terminal apparatus among jobs stored in the job storage by collating the transmission history received by the transmission history receiver and the receipt history stored in the receipt history storage.

This application claims priority under 35 U.S.C. §119 to Japanese Patent Application No. 2006-200118 filed on Jul. 21, 2006, the entire disclosure of which is incorporated herein by reference in its entirety.

### BACKGROUND OF THE INVENTION

1. Field of the Invention

The present invention relates to a job processing system equipped with a portable terminal apparatus such as a cellular phone and a job processing apparatus such as an image forming apparatus, a job processing apparatus for use in the system, a job identifying method for identifying a job, and a computer readable recording medium storing a job identifying processing program therein to make a computer execute job identifying processing.

2. Description of the Related Art

The following description sets forth the inventor's knowledge of related art and problems therein and should not be construed as an admission of knowledge in the prior art.

In a job processing system, it is known to configure such that various jobs, such as a print job, are transmitted from a terminal apparatus, such as a cellular phone and a personal computer, to a job processing apparatus, such as a MFP (Multi Function Peripheral) which is a multi-function digital complex machine and saved in the job processing apparatus and then a user comes to the job processing apparatus to execute the transmitted and saved job.

In this system, in order to execute a job, it is required for a user who came to the job processing apparatus to identify the job transmitted by the user. However, it is troublesome for the user to identify the job based on information inputted from an operation panel, which deteriorates the operability.

To cope with this issue, there is a heretofore known technique in which when a user carrying a cellular phone approaches, the printer's peculiar information will be automatically transmitted to a document server to print out the print data addressed to the recipient who is the owner of the cellular phone.

Furthermore, there is a heretofore known technique in which when a user carrying a cellular phone approaches an image forming apparatus, print processing will automatically start.

Furthermore, there is a heretofore known technique in which when a job is transmitted from a user terminal to a printer, the identification information peculiar to the job will be transmitted to a cellular phone. When a user carrying the cellular phone approaches the printer, the identification information of the job will be automatically transmitted from the cellular phone to the printer to execute the job.

In the former two techniques introduced right above, however, there exists a problem that all of the jobs addressed to a recipient will be outputted and therefore only a specified job addressed to the recipient cannot be outputted.

On the other hand, in the latter technique introduced above, it is necessary to transmit the identification information peculiar to the job to the cellular phone. Therefore, due to a possible wrong address or transmission error, it is not always to correctly transmit only to the correct cellular phone. In the case of a wrong address, the job will be outputted by another person. In the case of a transmission error, no print job will be outputted from the printer, which burdens the resource, such as, e.g., a memory of the printer.

The description herein of advantages and disadvantages of various features, embodiments, methods, and device disclosed in other publications is in no way intended to limit the present invention. Indeed, certain features of the invention may be capable of overcoming certain disadvantages, while still retaining some or all of the features, embodiments, methods, and device disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a job processing system capable of assuredly identifying a job intended by a user and preventing a wrong job output at the time of executing the job transmitted by the user.

Among other potential advantages, some embodiments can provide a job processing apparatus capable of assuredly identifying a job intended by a user and preventing a wrong job output at the time of executing the job transmitted by the user.

Among other potential advantages, some embodiments can provide a job identifying method capable of assuredly identifying a job intended by a user and preventing a wrong job output at the time of executing the job transmitted by the user.

Among other potential advantages, some embodiments can provide a computer readable recording medium which stores a job identification processing program therein to make a computer execute job identifying processing.

According to a first aspect of the preferred embodiment of the present invention, a job processing system is equipped with a portable terminal apparatus and a job processing apparatus,

wherein the portable terminal apparatus comprises:

a transmission history storage that stores a transmission history of a job transmitted to the job processing apparatus; and

a transmitter that transmits the stored transmission history to the job processing apparatus, and

wherein the job processing apparatus comprises:

a job receiver that receives the job;

a job storage that stores the received job;

a receipt history storage that stores a receipt history of the received job;

a transmission history receiver that receives the transmission history from the portable terminal apparatus; and

a history collator that identifies a job corresponding to the transmission history of the portable terminal apparatus among jobs stored in the job storage by collating the transmission history received by the transmission history receiver and the receipt history stored in the receipt history storage.

According to a second aspect of the preferred embodiment of the present invention, a job processing system is equipped with a portable terminal apparatus, a first job processing apparatus and a second job processing apparatus,

wherein the portable terminal apparatus comprises:

a transmission history storage that stores a transmission history of a job transmitted to the job processing apparatus; and

a transmitter that transmits the stored transmission history to the job processing apparatus, and

wherein the first job processing apparatus comprises:

a job receiver that receives the job;

a job storage that stores the received job;

a receipt history storage that stores a receipt history of the received job; and

a history collator that identifies the job corresponding to the transmission history of the portable terminal apparatus among jobs stored in the job storage by collating the transmission history of the portable terminal apparatus transmitted from the second job processing apparatus and the receipt history stored in the receipt history storage, and

wherein the second job processing apparatus comprises:

a transmission history receiver that receives the transmission history from the portable terminal apparatus; and

a transmitter that transmits the received transmission history to the first job processing apparatus.

According to a third aspect of the preferred embodiment of the present invention, a job processing system is equipped with a portable terminal apparatus, a first job processing apparatus and a second job processing apparatus,

wherein the portable terminal apparatus comprises:

a transmission history storage that stores a transmission history of a job transmitted to the job processing apparatus; and

a transmitter that transmits the stored transmission history to the job processing apparatus, and

wherein the first job processing apparatus comprises:

a job receiver that receives a job;

a job storage that stores the received job;

a receipt history storage that stores a receipt history of the received job; and

a transmitter that transmits the receipt history stored in the receipt history storage to the second job processing apparatus, and

wherein the second job processing apparatus comprises:

a transmission history receiver that receives the transmission history transmitted from the portable terminal apparatus;

a receipt history receiver that receives the receipt history transmitted from the first job processing apparatus; and

a history collator that identifies a job corresponding to the transmission history of the portable terminal apparatus among jobs stored in the job storage by collating the transmission history from the portable terminal apparatus and the receipt history from the first job processing apparatus.

According to a fourth aspect of the preferred embodiment of the present invention, A job processing apparatus comprises:

a job receiver that receives a job;

a job storage that stores the received job;

a receipt history storage that stores a receipt history of the received job;

a transmission history receiver that receives a job transmission history stored in the portable terminal apparatus; and

a history collator that identifies a job corresponding to the transmission history of the portable terminal apparatus among jobs stored in the job storage by collating the transmission history received by the transmission history receiver and the receipt history stored in the receipt history storage.

According to a fifth aspect of the preferred embodiment of the present invention, a job identifying method comprises:

a step of receiving a job;

a step of storing the received job;

a step of storing a receipt history of the received job;

a step of receiving a transmission history of a job stored in a portable terminal apparatus; and

a step of identifying a job corresponding to the transmission history of the portable terminal apparatus among the stored jobs by collating the received transmission history and the stored receipt history.

According to a sixth aspect of the preferred embodiment of the present invention, a computer readable recording medium stores a job identifying processing program therein to make a computer execute:

a step of receiving a job;

a step of storing the received job;

a step of storing a receipt history of the received job;

a step of receiving a transmission history of a job stored in a portable terminal apparatus; and

a step of identifying a job corresponding to the transmission history of the portable terminal apparatus among the stored jobs by collating the received transmission history and the stored receipt history.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a schematic structural view showing a job processing system to which a job processing apparatus according to one embodiment of the invention is applied;

FIG. 2 is a block diagram showing each electrical structure of MFPs and a cellular phone in the job processing system;

FIG. 3 is an explanatory view schematically showing an operation of the job processing system in cases where a MFP automatically obtains document information from a personal computer on a network;

FIG. 4 is an explanatory view schematically showing an operation of the job processing system in cases where a user approaches a MFP which is different from a MFP storing a job;

FIG. 5 is an explanatory view schematically showing an operation of the job processing system in cases where a job in which a transmission history and a receipt history coincide could not be identified;

FIG. 6A shows an example of a transmission history in the cellular phone, FIG. 6B shows an example of a receipt history in a MFP, and FIG. 6C shows an example of a receipt history in another MFP;

FIG. 7 is a flowchart showing a flow of the processing to be executed in a MFP when a job instruction was received from the cellular phone;

FIG. 8 is a flowchart showing a subroutine of the detection processing (Step S2) of the cellular phone shown in FIG. 7;

FIG. 9 is a flowchart continued from FIG. 8;

FIG. 10 is a flowchart showing a subroutine of the e-mail receiving processing (Step S4) shown in FIG. 7;

FIG. 11 is a flowchart showing the processing to be executed in the cellular phone;

FIG. 12 shows a login regular default screen to be displayed on the operation panel of a MFP;

FIG. 13 shows a function selection screen to be displayed on the operation panel of a MFP;

FIG. 14 shows a job selection screen to be displayed on the operation panel of a MFP; and

FIG. 15 is a flowchart showing the processing for an authentication by a user ID comparison to be executed in place of an authentication by an authentication server.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

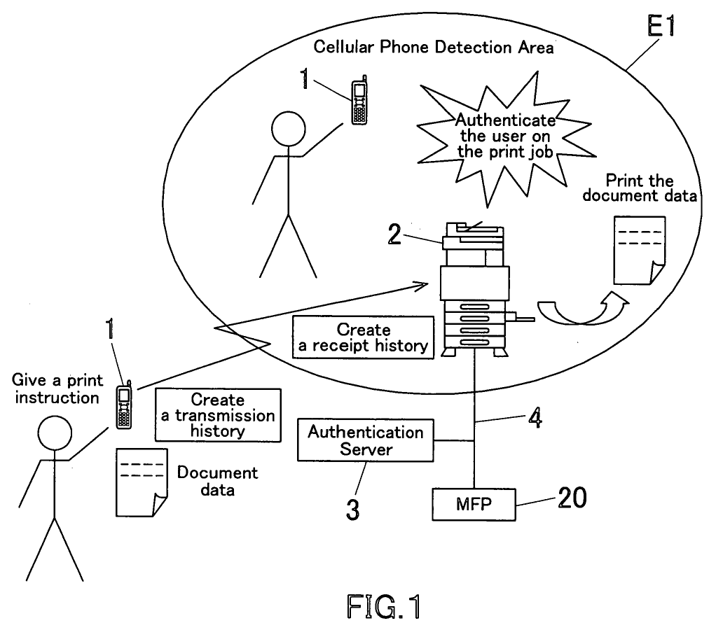

As shown in FIG. 1, the job processing system according to an embodiment of this invention is equipped with a cellular phone 1 as a portable terminal apparatus, MFPs 2 and 20 as job processing apparatuses, and an authentication server 3. The MFP 2, the MFP 20 and the authentication server 3 are mutually connected via a network 4, such as, e.g., a LAN.

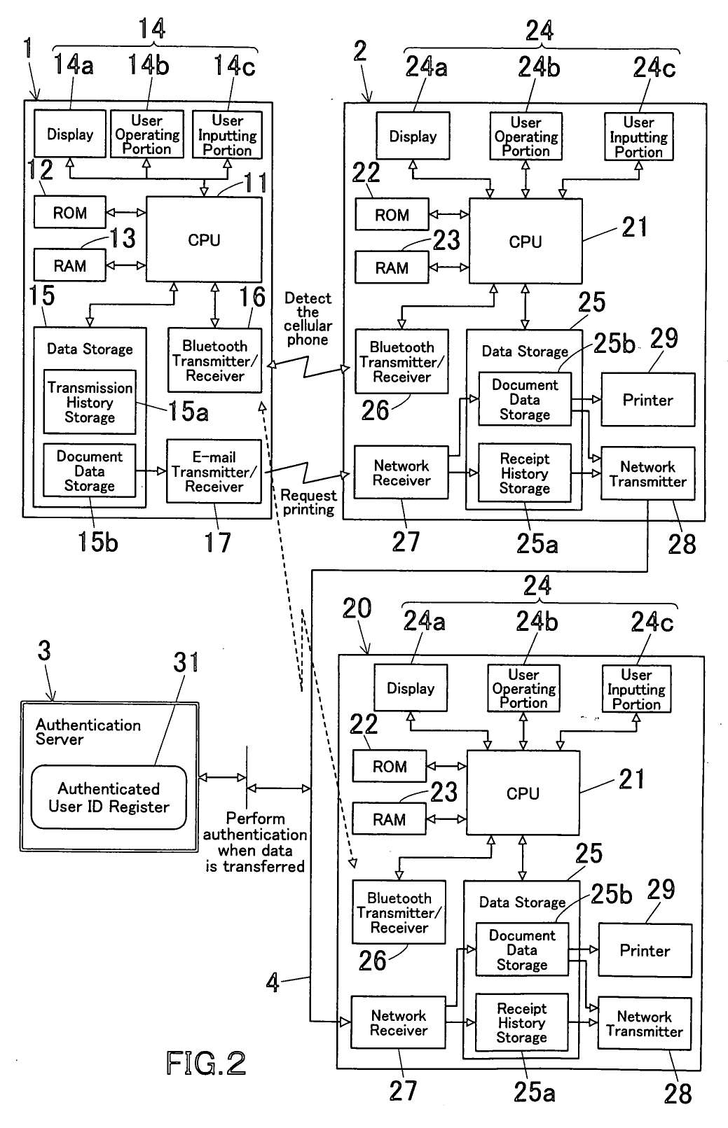

As shown in the block diagram of FIG. 2, the portable cellular phone 1 is configured to create document data (including image data) and transmit it to the MFP 2 by e-mail, and is equipped with a CPU 11, a ROM 12, a RAM 13, an operation panel 14, a data storage 15, a Bluetooth transmitter/receiver 16, and an e-mail transmitter/receiver 17.

The CPU 11 generally controls the entire operation of the cellular phone 1. In this embodiment, the CPU 11 has a function of creating a transmission history every time document data (a job) is transmitted to the MFP 2. The ROM 12 is a memory for storing, e.g., an operation program for the CPU 11. The RAM 13 is a memory for providing a working area for the operation of the operation program to be executed by the CPU 11.

The operation panel 14 has a display 14a, a user operating portion 14b and a user inputting portion 14c. The display 14a is configured to display, e.g., a mode status and various messages. Furthermore, the user operating portion 14b has, e.g., a mode selection key. The user inputting portion 14c is used to issue various instructions.

The data storage 15 has a transmission history storage 15a for storing the created transmission history, and a document data storage 15b for storing document data.

The Bluetooth transmitter/receiver 16 is used to perform communication with the MFP 2 and MFP 20 by a Bluetooth communication method. The communication method is not limited to the Bluetooth communication method.

The e-mail transmitter/receiver 17 is used to transmit/receive e-mails.

The portable terminal apparatus is not limited to the cellular phone 1, and can be a PDA (Personal Digital Assistant) for example.

The MFP 2 and the MFP 20 are the same in structure, and therefore the following explanation will be directed only to the MFP 2.

The MFP 2 is equipped with a CPU 21, a ROM 22, a RAM 23, an operation panel 24, a data storage 25, a Bluetooth transmitter/receiver 26, a network receiver 27, a network transmitter 28 and an printer 29.

The CPU 21 controls the entire operation of the MFP 2. In this embodiment, the CPU 21 has a function of creating a receipt history and a history collation function of identifying the job issued by the user of the cellular phone 1 corresponding to the transmission history by collating the transmission history stored in the cellular phone 1 and the receipt history stored in the MFP 2.

The ROM 22 is a memory for storing, e.g., an operation program for the CPU 21. The RAM 23 is a memory for providing a working area for the operation of the operation program to be executed by the CPU 21.

The operation panel 24 has a display 24a, a user operating portion 24b and a user inputting portion 24c. The display 24a is configured to display, e.g., a mode status and various messages. Furthermore, the user operating portion 24b has, e.g., a mode selection key. The user inputting portion 24c is used to issue various instructions.

The data storage 25 is constituted by, e.g., a hard disk (HDD), and has a receipt history storage 25a for storing the receipt transmission history, and a document data storage 25b for storing the received document data.

The Bluetooth transmitter/receiver 26 is used to communicate with the Bluetooth transmitter/receiver 16 of the cellular phone 1 by a Bluetooth communication method, and continuously detects whether or not the cellular phone 1 exists within a Bluetooth communication available detection area E1 (see FIG. 1). When the cellular phone 1 enters in the detection area E1, the Bluetooth transmitter/receiver 26 automatically initiates the communication with the cellular phone 1. Thus, the fact that the user of the cellular phone 1 approached the MFP 2 is automatically detected. Communication with the cellular phone 1 other than a job transmission/receipt by e-mail will be performed via the Bluetooth transmitter/receiver 16. It should be noted that the communication method is not limited to the Bluetooth communication method.

The detection that the cellular phone 1 has approached the MFP 2 can be performed separately from communication. For example, it can be configured such that the cellular phone 1 is equipped with an RF tag for Radio Frequency Identification and the MFP 2 is equipped with a reader and that after detecting the approach of the cellular phone 1, communications are initiated.

The network receiver 27 is configured to receive, for example, e-mails from the cellular phone 1 and the data from the MFP 20, the authentication server 3, personal computers, etc. The MFP 2 has a mail server function and receives e-mails via the network receiver 27.

The network transmitter 28 is configured to transmit data to the MFP 20, the authentication server 3, personal computers, etc.

The authentication server 3 has, e.g., an authenticated user ID register 31. When a user inputted his/her user ID from the login screen on the operation panel 24, or when a user accessed the MFP 2 by the cellular phone 1, personal computer, etc. and the user ID is sent from the MFP 2, the authentication server 3 collates the user ID with an ID of a registered authenticated user to administrate whether the permission of the use of the MFP 2 is given to the user. The administration result by the authentication server 3 will be transmitted to the MFP 2 via the network 4.

Next, the schematic operation of the job processing system shown in FIGS. 1 and 2 will be explained with reference to FIG. 1.

(1) A user e-mails document data (a print job) from the cellular phone 1 to the MFP 2. In the cellular phone 1, in e-mailing the document data, a name of the destination MFP 2 is set and then the document data is attached to the e-mail.

At this time, in the cellular phone 1, a transmission history is created and saved in the transmission history storage 15a of the data storage 15.

On the other hand, in the MFP 2, when it receives the e-mail from the cellular phone 1, the document data is stored in the document data storage 25b and the receipt history is stored in the receipt history storage 25a.

(2) When the user carrying the cellular phone 1 moves in the cellular phone detection area E1 of the MFP 2, the MFP 2 detects the cellular phone 1 via the Bluetooth transmitter/receiver 26 and the Bluetooth transmitter/receiver 16 of the cellular phone 1, and automatically sends a request to the cellular phone 1 for the transmission history.

When the transmission history is transmitted from the cellular phone 1, after receiving the transmission history, the MFP 2 performs the authentication of the user carrying the cellular phone 1.

(3) If the authentication is successfully performed, the MFP 2 collates the transmission history transmitted from the cellular phone 1 with the receipt history stored in the MFP 2 to identify the document data corresponding to the transmission history of the user (job transmitter) carrying the cellular phone 1, and then authorizes the print output of the document data.

(4) The document data will be automatically printed out from the printer 29 of the MFP 2.

As will be apparent from the above, when the user carrying the cellular phone 1 storing the transmission history of the job approaches the MFP 2, the job can be easily identified and the identified job can be automatically executed. As a result, the user can get relief from troublesome operations. Furthermore, only the job corresponding to the transmission history can be assuredly identified, which can solve the drawbacks that all of the user's jobs will be outputted. Furthermore, since it is not the system that the identification information peculiar to the job is transmitted to the cellular phone and the job is identified using this identification information, there is no possibility of the cellular phone's recipient errors and/or transmission errors of the identification information.

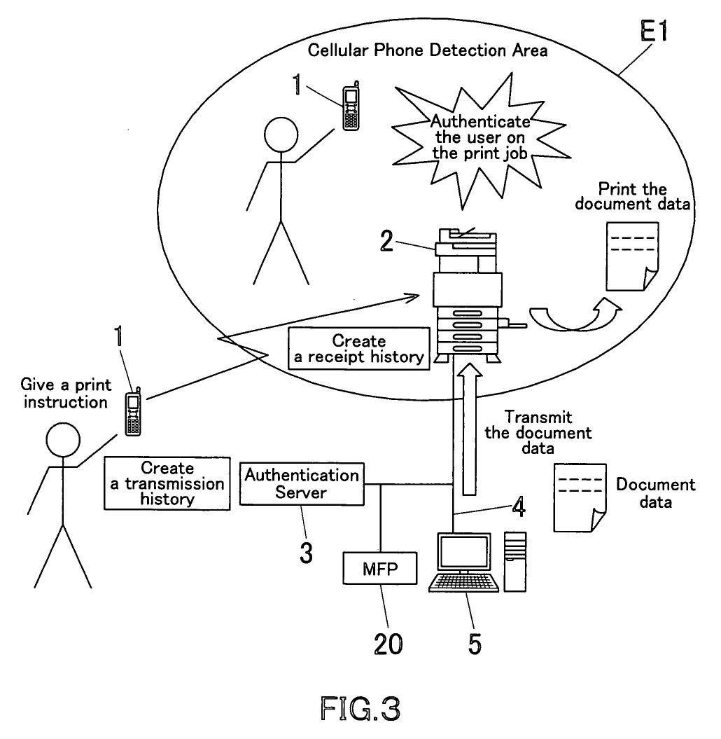

In the embodiment shown in FIG. 1, the user transmitted the job using the cellular phone 1, but not limited thereto. In place of the above, it can be configured as shown in FIG. 3. That is, the user e-mails to the MFP 2 only a job instruction including the document storing designation. Upon receipt of the instruction from the cellular phone 1, the MFP 2 creates the receipt history and automatically requests the personal computer 5 (hereinafter referred to as “PC”) which is the document storing destination to transmit the identified document, to obtain and save the document data.

A document stored in a file server (not illustrated) can be identified in place of the document stored in a PC 5. Alternatively, a document previously stored in the BOX which is a storing area in the MFP 2 can be identified.

In the system shown in FIG. 3, the processing to be performed when a user carrying the cellular phone 1 approaches the MFP 2 is the same as in the system shown in FIG. 1, and therefore its detailed explanation will be omitted.

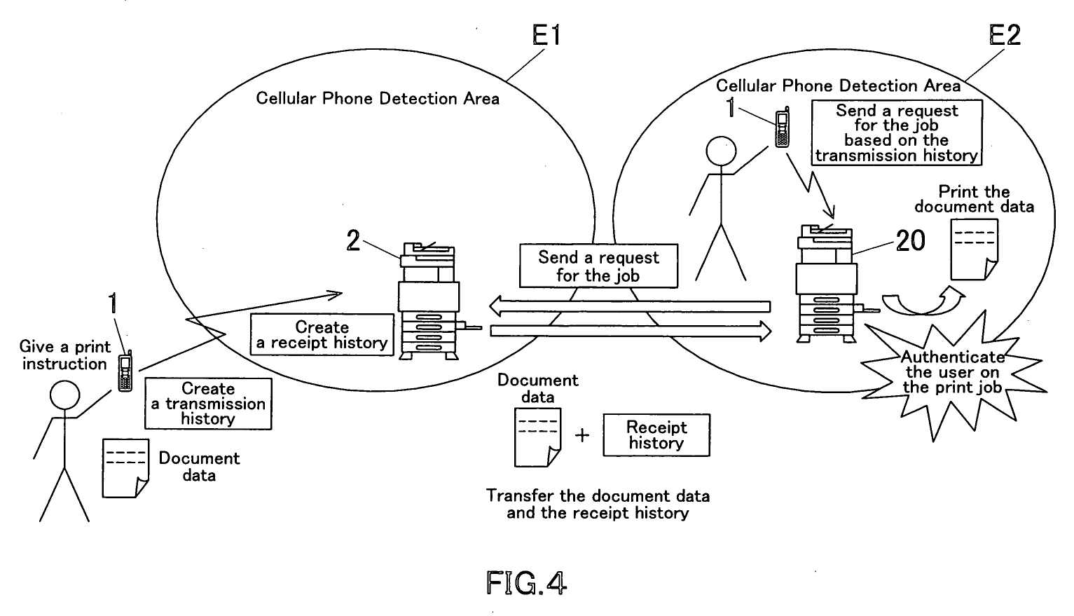

FIG. 4 is a schematic view showing an operation of the job processing system in the case where a user carrying the cellular phone 1 approaches the MFP 20 which is different from the MFP 2 storing a job.

(1) A user e-mails a print job including document data from the cellular phone 1 to the MFP 2. In the cellular phone 1, in e-mailing the job, a name of the destination MFP 2 is set and then the document data is attached to the e-mail.

At this time, in the cellular phone 1, a transmission history is created and saved in the transmission history storage 15a of the data storage 15.

On the other hand, in the MFP 2, when it receives the e-mail from the cellular phone 1, the job data including the document data is stored in the document data storage 25b and the receipt history is stored in the receipt history storage 25a.

(2) When the user carrying the cellular phone 1 moves in the cellular phone detection area E2 of the MFP 20 which is different from the MFP 2 storing the job, the MFP 20 detects the cellular phone 1 via the Bluetooth transmitter/receiver 26 and the Bluetooth transmitter/receiver 16 of the cellular phone 1, and automatically requests the cellular phone 1 to transmit the transmission history.

When the transmission history is transmitted from the cellular phone 1, after receiving the transmission history, the MFP 20 obtains the address (which will be explained later) of the MFP 2 contained in the received transmission history and requests the MFP 2 to transfer the document (print job) and the receipt history.

In the MFP 20, the authentication of the user carrying the cellular phone 1 is performed. After the document and the receipt history are transferred from the MFP 2 to the MFP 20, the authentication of the user is performed using the authentication server 3 based on the history.

(3) If the authentication is successfully performed, the MFP 20 collates the transmission history with the transferred receipt history to identify the job corresponding to the transmission history of the user (job transmitter) carrying the cellular phone 1, and then authorizes the print output of the job.

(4) The job will be automatically printed out from the printer 29 of the MFP 20.

As will be apparent from the above, in this embodiment, when the user carrying the cellular phone 1 storing the job transmission history approaches the MFP 20 which is different from the MFP 2 storing the print job, the job can be easily identified and the identified job can be automatically executed. As a result, the user can get relief from troublesome operations. Furthermore, only the job corresponding to the transmission history can be assuredly identified, which can solve the drawbacks that all of the user's jobs will be outputted. Furthermore, without specifying any MFP to execute the job, it becomes possible for the user to output the job from a MFP located near the user. Accordingly, no mistake that the job cannot be outputted due to the wrong specification of the MFP will occur.

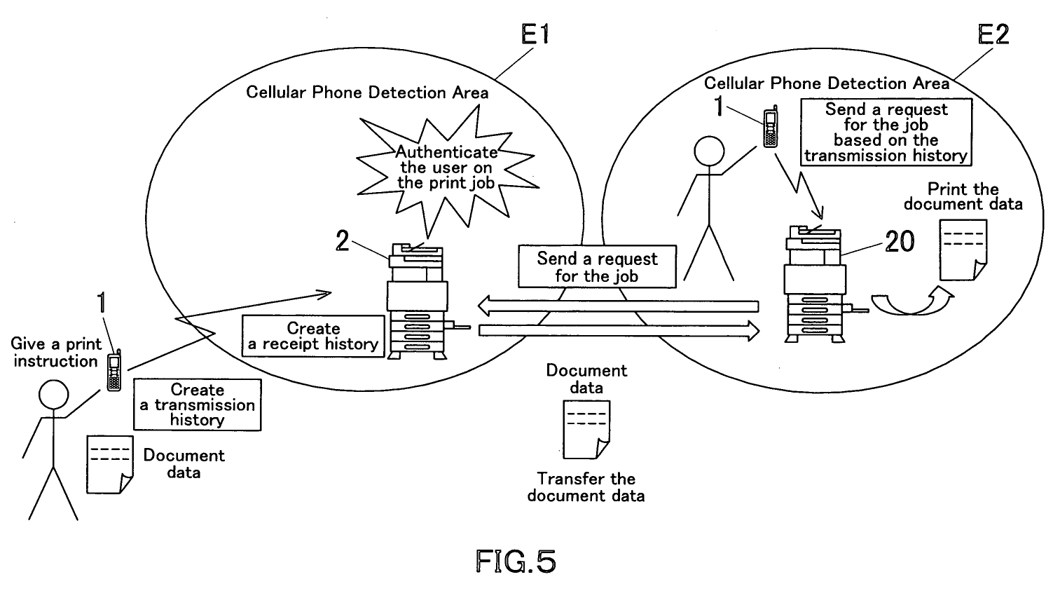

In the embodiment shown in FIG. 4, the MFP 20 which is different from the MFP 2 storing the job obtained the document and the receipt history from the MFP 2, and performed the user authentication and the job identification by the collation of the receipt history and the transmission history. In place of the above, as shown in FIG. 5, it can be configured such that the transmission history from the cellular phone 1 is transmitted to the MFP 20 and the user authentication and the job identification by the collation of the receipt history and the transmission history is performed by the MFP 2. The operation of this case will be explained as follows.

(1) A user e-mails document data (a job) from the cellular phone 1 to the MFP 2. In the cellular phone 1, in e-mailing the document data, a name of the destination MFP 2 is set and then the document data is attached to the e-mail.

At this time, in the cellular phone 1, a transmission history is created and saved in the transmission history storage 15a of the data storage 15.

On the other hand, in the MFP 2, when it receives the e-mail from the cellular phone 1, the job data including the document data is stored in the job data storage 25b and the receipt history is stored in the receipt history storage 25a.

(2) When the user carrying the cellular phone 1 moves in the cellular phone detection area E2 of the MFP 20 which is different from the MFP 2 storing the job, the MFP 20 detects the cellular phone 1 via the Bluetooth transmitter/receiver 26 and the Bluetooth transmitter/receiver 16 of the cellular phone 1, and automatically requests the cellular phone 1 to transmit the transmission history.

When the transmission history is transmitted from the cellular phone 1, after receiving the transmission history, the MFP 20 obtains the address (which will be explained later) of the MFP 2 contained in the received transmission history and transfers the transmission history to the MFP 2 to identify the print job.

In the MFP 2, upon receiving the transmission history, the authentication of the user carrying the cellular phone 1 is performed.

(3) In the MFP 2, if the authentication is successfully performed, the MFP 2 collates the receipt history with the transferred transmission history to identify the job corresponding to the transmission history of the user (job transmitter) carrying the cellular phone 1. Then, the MFP 2 authorizes the print output of the job and transfers the job to the MFP 20.

(4) In MFP 20, the document data of the transferred job will be automatically printed out from the printer 29.

As will be apparent from the above, also in this embodiment, when the user carrying the cellular phone 1 storing the job transmission history approaches the MFP 20 which is different from the MFP 2 storing the print job, the job can be easily identified and the identified job can be automatically executed. As a result, the user can get relief from troublesome operations. Furthermore, only the job corresponding to the transmission history can be assuredly identified, which can solve the drawbacks that all of the user's jobs will be outputted. Furthermore, without specifying any MFP to execute the job, no mistake that the job cannot be outputted due to the wrong specification of the MFP will occur.

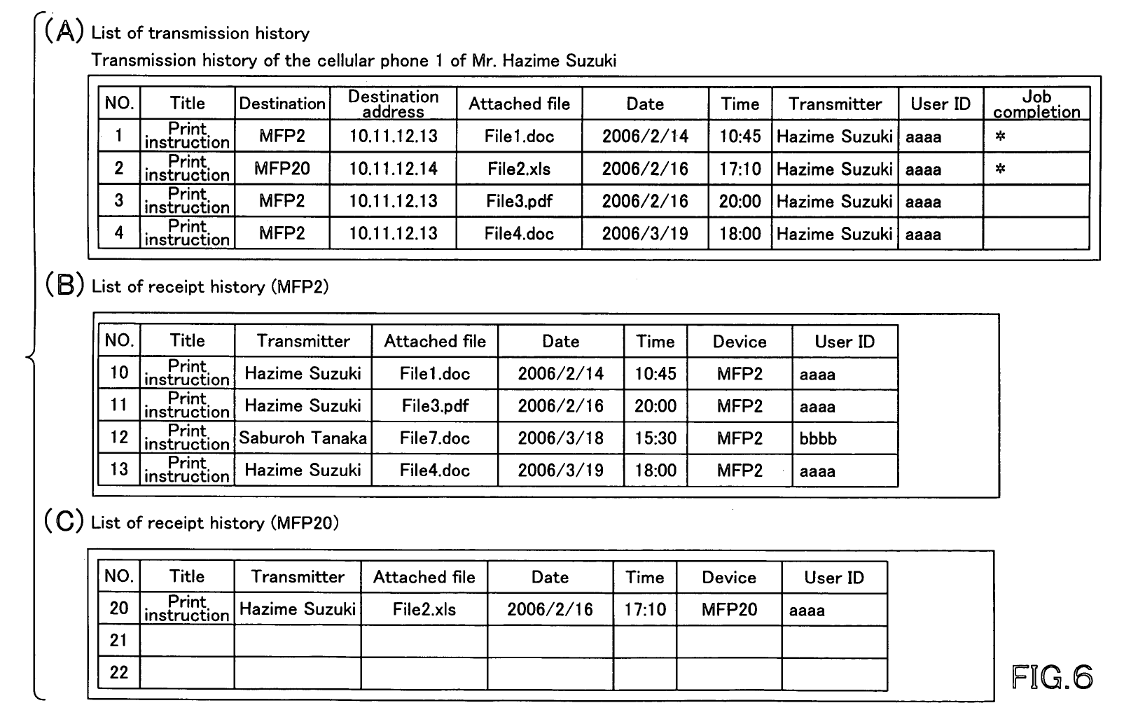

Examples of a transmission history of a job stored in the cellular phone 1 and a receipt history of a job stored in the MFP 2 or MFP 20 are shown in FIG. 6.

FIG. 6(A) shows an example of a transmission history of the cellular phone 1.

This transmission history contains items, such as, e.g., title showing a job, job destination, destination address, attached file name, transmission date, transmission time, transmitter name, user ID, and job completion check. Since the transmission history contains a job completion check, the cellular phone 1 can transmit transmission histories only of unexecuted jobs to a MFP.

The item of transmitter name can be omitted since the transmitter is the owner of the cellular phone 1.

FIG. 6(B) is an example of a receipt history in the MFP 2.

This receipt history contains items, such as, e.g., title showing a job, transmitter name, attached file name, receipt date, receipt time, device name (the name of the MFP 2) which received the job, and user ID.

Since the device name which received the job is apparently the MFP 2, this item can be omitted.

FIG. 6(C) is an example of a receipt history in the MFP 20, and contains the same items as in FIG. 6(B)

The example of FIG. 6 shows the case in which the print jobs of No. 1 and No. 3 in the transmission history of the cellular phone 1 was transmitted to the MFP 2 and the print job of No. 2 was transmitted to the MFP 20.

In the example of FIG. 6, in cases where the MFP 2 identifies a job by collating the unexecuted jobs (which will be explained later) among jobs in the receipt history with the receipt history, it is discriminated whether the title, the transmitter, the attached file name, the date and the time coincide with each other and whether the destination and the device name coincide with each other. If it is discriminated that they coincide with each other, it is discriminated that the print job corresponding to the receipt history is the job transmitted by the user, and then the job is printed out. In place of the above, the discrimination can be made based on whether the transmitter name and the transmission/receipt time coincide with each other.

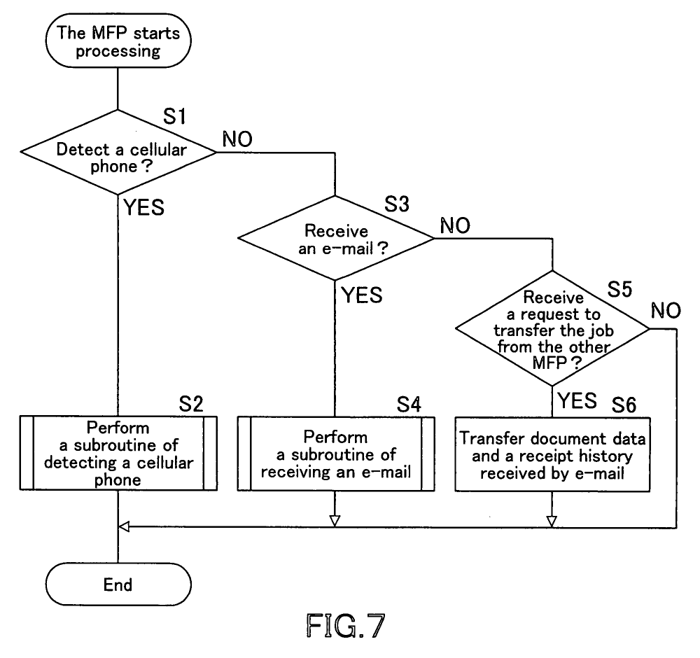

The processing to be performed by the MFP 2(20) which received the print job from the cellular phone 1 will be explained with reference to the flowchart shown in FIG. 7. This processing is executed by the operation of the CPU 21 of the MFP 2(20) in accordance with the operation program stored in a recording medium, such as, e.g., the ROM 22. The following each flowchart contains the processing to be performed in both the MFP 2 and the MFP 20 shown in FIGS. 1, 3 and 4, which should be read respectively.

In FIG. 7, at Step S1, it is discriminated whether the cellular phone 1 is detected. If the cellular phone 1 enters in the cellular phone detection area E1 and the cellular phone 1 is detected (YES at Step S1), then a subroutine of detecting the cellular phone 1 is performed at Step S2. And then the routine terminates.

If the cellular phone 1 is not detected (NO at Step S1), it is discriminated at Step S3 whether an e-mail was received. If an e-mail was received (YES at Step S3), then a subroutine of receiving an e-mail is performed at Step S4. And then the routine terminates.

If no e-mail was received (NO at Step S3), it is discriminated at Step 5 whether a transmission request from the MFP 20 was received. If a transmission request from the MFP 20 was received (YES at Step S5), after transmitting the received document (job) and the receipt history to the MFP 20, the routine terminates. If no transmission request from the MFP 20 was received (NO at Step S5), the routine terminates as it is.

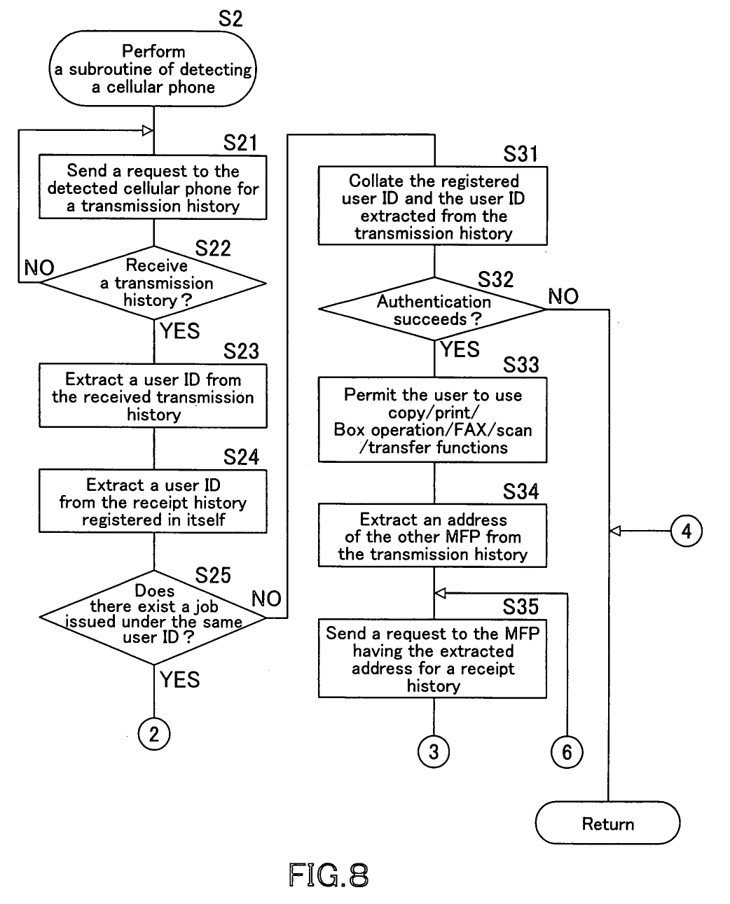

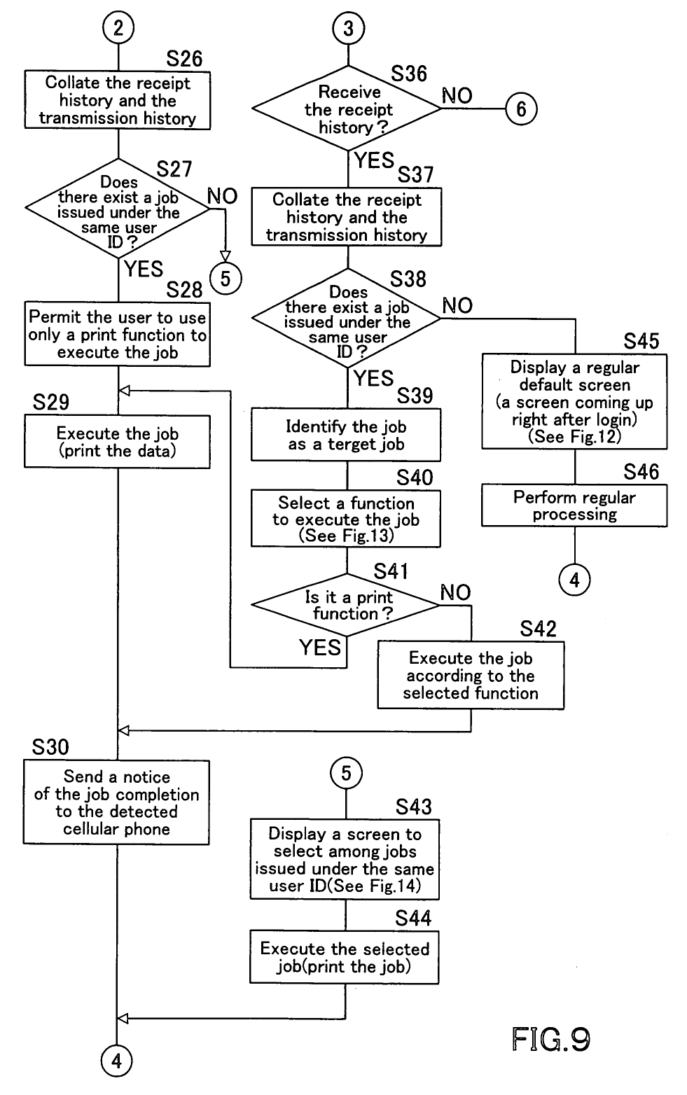

The subroutine of detecting the cellular phone (Step S2 in FIG. 7) will be explained with referenced to the flowcharts shown in FIGS. 8 and 9.

In FIGS. 8 and 9, at Step S21, a transmission request of the transmission history to the detected cellular phone 1 is performed. At Step 22, it is discriminated whether the transmission history from the cellular phone 1 was received. If the transmission history was not received (NO at Step S22), the routine returns to Step S21 and repeats the transmission request processing.

If the transmission history was received (YES at Step S22), the user ID is extracted from the received transmission history at Step S23 and the user ID is extracted from the receipt history stored in the MFP 2 at Step S24. Then, at Step S25, an authentication is performed by discriminating whether there exists a job in which the user ID extracted from the received transmission history coincides with the user ID extracted from the receipt history.

The reason that an authentication is performed by collating the user IDs at the time of identifying the job is as follows. That is, when the print job was received by e-mail from the cellular phone 1, an authentication was once performed by the authentication server 3, which will be explained later. Therefore, in the authentication for identifying the job of this time, the security can be established by simply collating the user ID of the receipt history with that of the transmission history without requesting an authentication to the authentication server 3. With this, the confirmation operation for the authentication can be simplified.

If there exists a user ID consistent job (YES at Step S25), the routine proceeds to Step S26 in FIG. 9 to collate the receipt history with the transmission history. At Step S27, it is discriminated whether there exists a user ID consistent job (as will be explained, transmission histories of only unexecuted jobs have been transmitted from the cellular phone 1).

If there exists a user ID consistent job (YES at Step S27), it is assumed that the user wishes the job print. At Step S28, a permission is given only to the job print function.

At Step S25, since no authentication by the external authentication server 3 has been performed, it is not preferable to give a permission to the use of another function from the view point of security. For example, it is not preferable to give a permission to the operation of the box (BOX) which is a storing area from the view point of secret information leakage. Furthermore, in transmitting an e-mail, it is not preferable that a spam mail is maliciously transmitted. Therefore, without giving a permission of transmitting/receiving an e-mail to/from outside via the network 4, a permission is given only to a specific print function to be processed only at the MFP 2.

Next, at Step S29, the user ID consistent job is executed (the data is printed out). At Step S30, a notice of the job completion is transmitted to the detected cellular phone 1. Then, the routine returns.

If there exists no user ID consistent job at Step S25 (NO at Step S25), this case is considered that the job is transmitted to another MFP and the receipt history is stored in another MFP. Accordingly, at Step S31, in the same manner as in normal processing, the user ID stored in the authentication server 3 and the user ID extracted from the transmission history are collated by the authentication server 3. At Step S32, based on the answer from the authentication server 3, it is discriminated whether the stored user ID and the user ID extracted from the transmission history coincide (whether the authentication is successful or unsuccessful). If the authentication is unsuccessful (NO at Step S32), it is treated as a lack of the right of use of the MFP 2, and the routine returns as it is.

If the authentication is successful (OK) (YES at Step S32), in the same manner as in the normal authentication processing, a permission to use all of the functions (Copy/Print/BOX operation/FAX/Scan/Transfer) is given to the user at Step S33. A permission/prohibition can be controlled based on the function restriction information previously set for each user.

At Step S34, an address of the other MFP is extracted from the transmission history to thereby identify the MFP 20 as the other MFP. At Step S35, a transmission of the receipt history and the document is requested to the MFP having the extracted address. At Step S36, it is discriminated whether the receipt history is received.

In the case where a receipt history is received (YES at Step S36), at Step S37, the receipt history and the transmission history are collated. Thereafter, at Step S38, it is discriminated whether there exists a consistent job. If a receipt history is not received (NO at Step S36), the routine returns to Step S35 to request a transmission of the receipt history again.

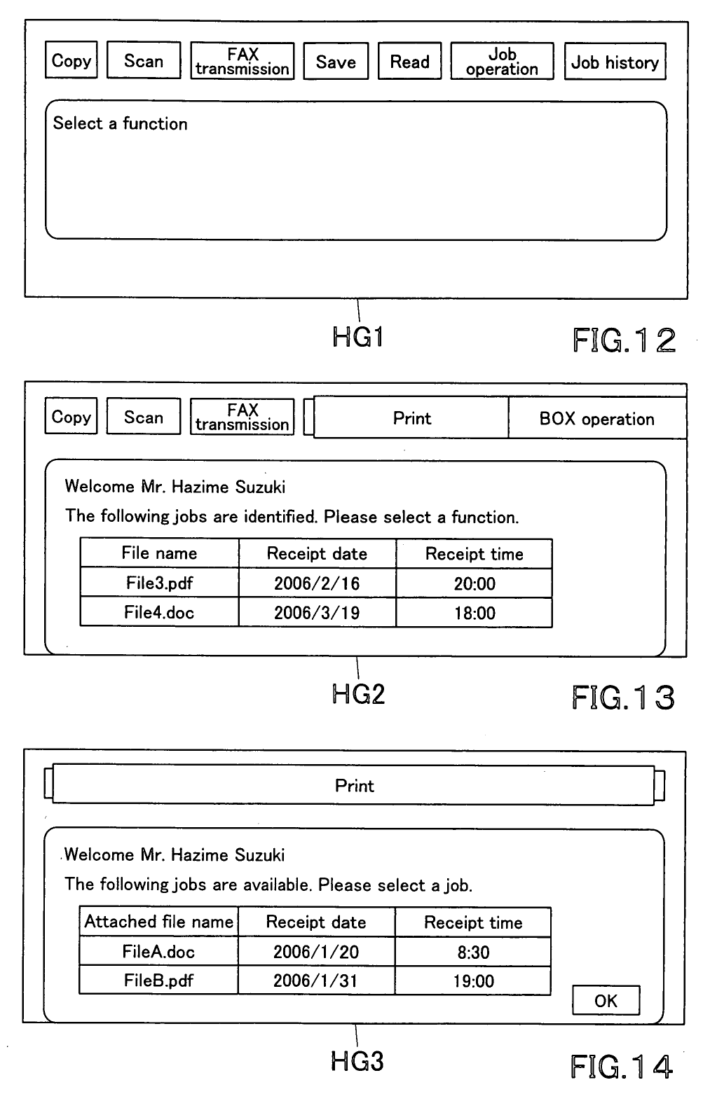

If there exists no consistent job (NO at Step S38), a regular default screen HG1 (see FIG. 12) which is a screen coming up right after login, is displayed at Step S45, and regular processing is performed at Step S46. Then, the routine returns.

In the regular default screen HG1 shown in FIG. 12, a message for inducing a function selection is displayed.

If there exists a consistent job at Step S38 (YES at Step S38), the consistent job is identified as a target job intended by the user at Step S39 and a function selection screen HG2 (see FIG. 13) is displayed at Step S40. Then, at Step S41, it is discriminated whether a print function is selected. In this example, since the authentication processing by the authentication server 3 has been already performed, the user is not limited to select a print function and can select any function in addition to a print function to secure a privilege as an authenticated user.

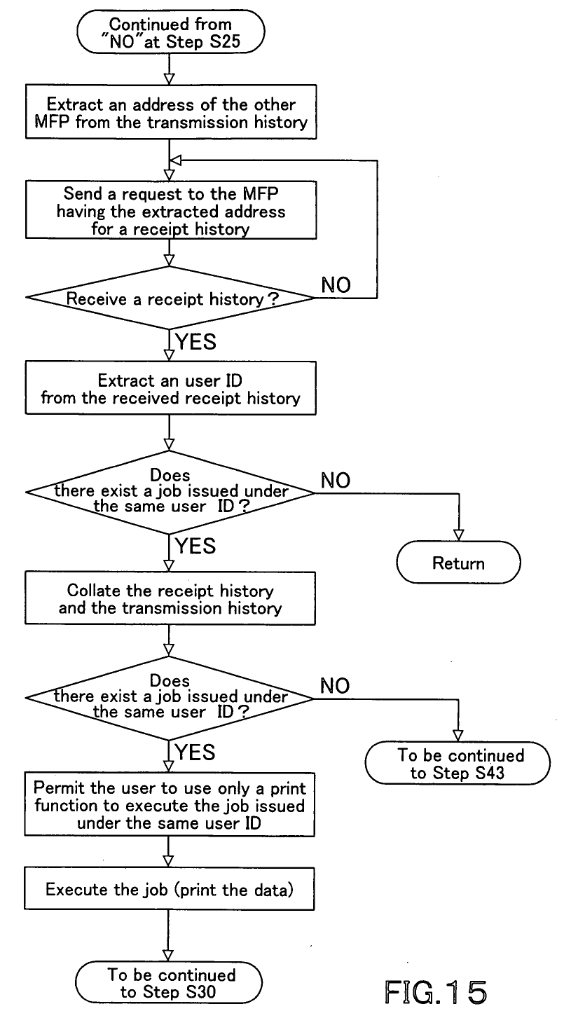

Furthermore, as shown in FIG. 15, in place of the authentication by the authentication server 3, an authentication by a user ID comparison such explained at Step S25 can be employed. That is, without performing the authentication at S31 and S32, the user ID to be extracted from the receipt history received at Step S36 and the user ID to be extracted from the previously received transmission history are collated to perform an authentication. In this case, however, since the authentication by the external authentication server 3 is not performed, a permission to use only a print function on a job in which the transmission history and the receipt history coincide in the same manner as explained at Step S28 is given to the user. Also in this case, in the same manner as explained at Step S25 to S27, only in the case where there exists a user ID consistent job, the comparison of the receipt history and the transmission history will be performed.

If a print job is selected (YES at Step S41), the routine proceeds to Step S29 to print out the selected job. Thereafter, at Step S30, the completion notice of the executed job is transmitted to the detected cellular phone 1. Then, the routine returns.

In the function selection screen HG2, job attributes, such as, e.g., file name, receipt date, and receipt time, are displayed.

If a print job is not selected (NO at Step S41), the job (a job other than a print job) corresponding to the selected function is executed, and then the routine proceeds to Step S30 to transmit the job completion notification.

At Step S27, as a result of the collation of the receipt history and the transmission history, if there exists no consistent job (NO at Step S27), the routine proceeds to Step S43 to display on a job selection screen HG3 (see FIG. 14) the list of jobs issued under the user ID from the receipt history, and the user selects from the list. Also in this case, since no user authentication is performed by the authentication server 3, permission is given only to a print job. When a job is selected by the user, the selected job is printed out at Step S44, and then the routine returns. This enables, for example, execution of a job instructed by another system.

In the job selection screen HG3, attached file names, receipt dates, receipt times, etc., are displayed.

In the above processing, the explanation is directed to the case in which transmission requests of the receipt history and the document to the MFP 20 are simultaneously performed at Step S35. In place of the above, it can be performed as follows. Initially, a transmission request only of the receipt history is performed to discriminated whether there exists a consistent job. If there exists a consistent job, a transmission request of the document of the job is performed to the MFP 20.

FIGS. 8 and 9 show operations of the MFP 2. The processing from and after Step S31 corresponds to the operation of the MFP 20, which is shown in FIG. 4 (both of the MFPs can process the same processing. In the above explanation, the MFP 2 is represented.)

Furthermore, in the embodiment shown in FIG. 5, i.e., in the embodiment in which a MFP other than a job received MFP transmits a transmission history received from the cellular phone 1 to the job received MFP to collate the transmission history and the receipt history therein and the consistent job is transmitted to the other MFP to print out thereby, the flowcharts shown in FIGS. 8 and 9 will be changed as follows.

That is, after transmitting at Step S35 the transmission history obtained from the cellular phone 1 to the MFP having the extracted address, the routine waits for the transmission of the collation result of the transmission history and the receipt history from the MFP at Step S36. If a job considered as a consistent job by the collation result is transmitted, the routine proceeds to Step S40 to perform the same processing as in the flowchart shown in FIG. 9. If there exists no consistent job, the routine proceeds to Step S45.

In the embodiment shown in FIG. 15, the processing will be changed as follows.

The transmission history obtained from the cellular phone is transmitted to the MFP having the address extracted at the Step of “extracting an address of another MFP from the transmission history” to request a user authentication for collating the user ID contained in the transmission history and the user ID contained in the receipt history. When the user authentication is successful, it is requested to transmit the collation result of the transmission history and the receipt history.

If a collation result showing that there exists no user ID consistent job is transmitted, the routine returns as it is. On the other hand, if there exists a user ID consistent job and a job in which the transmission history and the receipt history coincide as a result of the collation is transmitted, the routine proceeds to Step of “permitting the consistent job to be executed”, and then the same processing of the flowchart shown in FIG. 15 will be performed. In the case of no consistent job, the routine returns as it is.

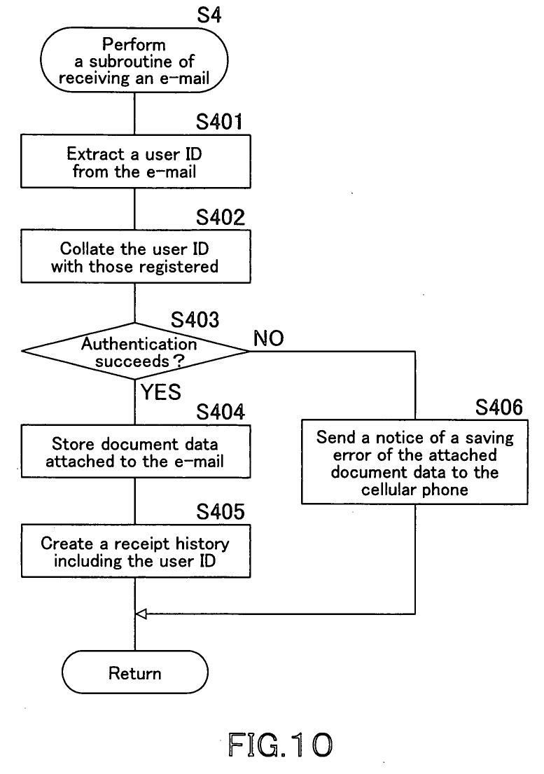

The subroutine of the e-mail receiving processing (Step S4 of FIG. 7) will be explained with reference to the flowchart shown in FIG. 10.

In FIG. 10, at Step S401, as the authentication processing, the user ID is extracted from the e-mail. At Step S402, the extracted user ID and the stored user ID are collated by the authentication server 3. At Step S403, it is discriminated whether the authentication is successful from the collation result by the authentication server 3.

If the authentication is successful (YES at Step S403), at Step S404, document data attached to the e-mail is saved. At Step S405, the receipt history including the user ID is created. Then, the routine returns. As shown in FIG. 3, in the embodiment in which the MFP 2 obtains document data from an external device such as the PC 5 or its own box based on an instruction from the cellular phone 1, at Step S404, the obtained document data is saved.

If the authentication is unsuccessful at Step S403 (NO at Step S403), after returning a notice of a saving error of the attached document to the cellular phone 1 at Step S406, the routine returns. In this case, the receipt history will not be created.

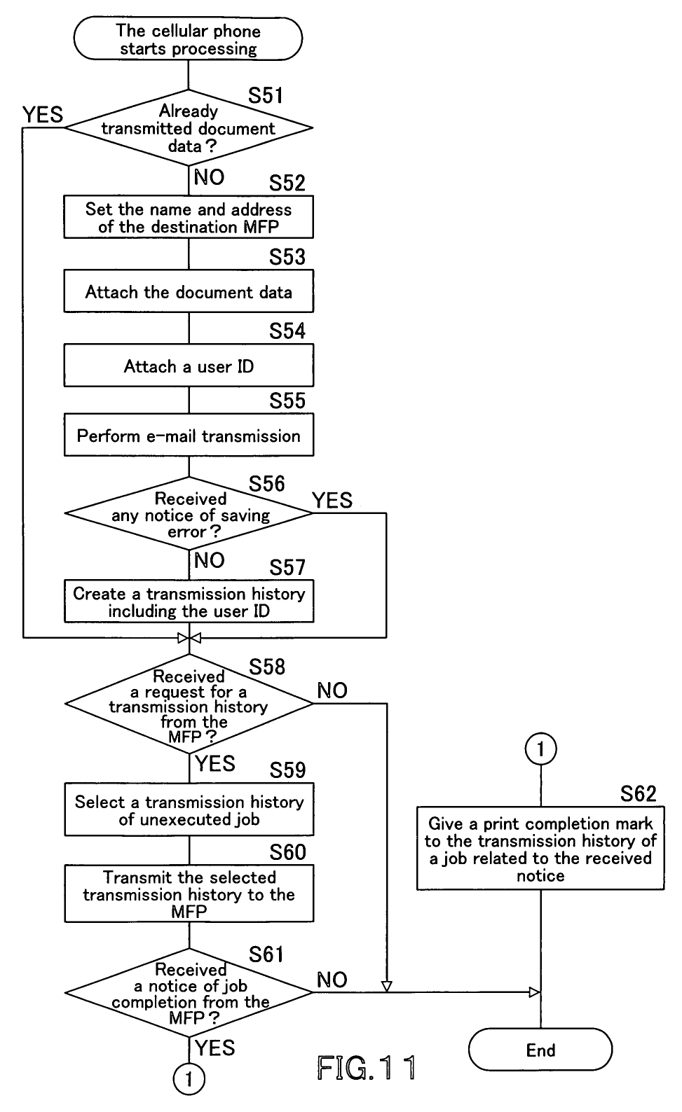

The processing to be performed by the cellular phone 1 will be explained with reference to the flowchart shown in FIG. 11.

In FIG. 11, at Step S51, it is discriminated whether a document has been transmitted. If the document has been already transmitted (YES at Step S51), the routine proceeds to Step S58.

If the document has not yet been transmitted (NO at Step S51), at Step S52, the name (MFP 2) and the address of the destination MFP are set. At Step S53, the document is attached. As shown in FIG. 3, in the embodiment in which the MFP 2 obtains specified document data according to an instruction given by the cellular phone 1, from an external device such as the PC 5 or its own box, a saving destination of the document data will be specified at Step S53. Subsequently, at Step S54, a user ID is attached. At Step S55, the e-mail transmission is performed.

Next, at Step S56, it is discriminated whether a notice of a saving error has not been received from the destination MFP 2, i.e., whether the authentication at the MFP 2 was successful and the document was normally saved.

If a notice of a saving error has not been received from the MFP 2 (NO at Step S56), the transmission history including the user ID is created at Step S57, and then the routine proceeds to Step S58. If a notice of a saving error is received from the MFP 2 (YES at Step S56), the routine proceeds to Step S58 as it is.

At Step S58, it is discriminated whether there exists a transmission request for a transmission history from the MFP 2 or MFP 20. If there exists a transmission request for a transmission history (YES at Step S58), a transmission history only of unexecuted job is selected at Step S59. At Step S60, the selected transmission history is transmitted to the MFP 2 or the MFP 20 that made the request, and then the routine proceeds to Step S61. If there exists no transmission request for a transmission history from the MFP (NO at Step S58), the routine terminates as it is.

At Step S61, it is discriminated whether a job completion notice is received from the MFP 2 or MFP 20. If a job completion notice is received (YES at Step S61), at Step S62, a print completion mark (a mark of “job completion” shown in FIG. 6(A)) is added to a transmission history of a job related to the received job completion notice. Thereafter, the routine terminates. If no job completion notice is received from the MFP 2 (NO at Step S61), the routine terminates as it is.

In the aforementioned embodiments, document data (a job) is transmitted from the cellular phone 1 as a portable terminal apparatus. In place of the above, it can be configured such that a job is transmitted from a personal computer, etc., the transmission history is transferred to a portable terminal apparatus, and then the portable terminal apparatus stores the transmission history.

### Summary of the Embodiments

A job processing system according to these embodiments, which is equipped with a portable terminal apparatus and a job processing apparatus, is configured such that the portable terminal apparatus comprises a transmission history storage for storing a transmission history of a job transmitted to the job processing apparatus, and a transmitter for transmitting the stored transmission history to the job processing apparatus. The job processing apparatus comprises a job receiver for receiving the job, a job storage for storing the received job, a receipt history storage for storing a receipt history of the received job, a transmission history receiver for receiving the transmission history from the portable terminal apparatus, and a history collator for identifying a job corresponding to the transmission history of the portable terminal apparatus among jobs stored in the job storage by collating the transmission history received by the transmission history receiver and the receipt history stored in the receipt history storage. Accordingly, the transmission history of the job is stored in the portable terminal apparatus, while the receipt history of the job is stored in the job processing apparatus. And, the job transmission history of the portable terminal apparatus is received by the job processing apparatus, the received transmission history and the receipt history stored in the job processing apparatus are collated to identify the job corresponding to the transmission history of the portable terminal apparatus among the jobs stored in the job storage.

As mentioned above, since the job processing apparatus identifies the job by collating the transmission history of the portable terminal apparatus and the receipt history owned by itself, the job corresponding to the transmission history can be assuredly identified, which solves drawbacks that all of the jobs addressed to the user will be printed out. Furthermore, the identification information peculiar to the job is not transmitted from the printer to the cellular phone, and therefore there is no possibility of causing troubles by a wrong address or a transmission error.

It can be configured such that the job processing apparatus discriminates whether there exists a consistent job in which user information included in the transmission history and user information included in the receipt history coincide and performs a collation of the transmission history and the receipt history only if there exists the consistent job. With this, the security to each job can be strengthened.

Furthermore, it can be configured such that the transmission history includes at least a user name who transmitted the job and a job transmission time, and the receipt history includes at least a user name who transmitted the job and a job receipt time, and wherein the history collator identifies a job by collating the user names of both the histories, the job transmission time and the job receipt time. In this case, the identification of the job can be performed with a high degree of accuracy.

Furthermore, it can be configured such that an instruction given on a job to be received by the job receiver and document data as an object of the job are transmitted to the job processing apparatus, from the portable terminal apparatus to the job processing apparatus or from an external device other than the portable terminal apparatus. With this, the identification of the job can be performed with a high degree of accuracy.

A job processing system according to these embodiments, which is equipped with a portable terminal apparatus, a first job processing apparatus and a second job processing apparatus, can be configured such that the portable terminal apparatus comprises a transmission history storage for storing a transmission history of a job transmitted to the job processing apparatus and a transmitter for transmitting the stored transmission history to the job processing apparatus, and wherein the first job processing apparatus comprises a job receiver for receiving the job, a job storage for storing the received job, a receipt history storage for storing a receipt history of the received job, and a history collator for identifying the job corresponding to the transmission history of the portable terminal apparatus among jobs stored in the job storage by collating the transmission history of the portable terminal apparatus transmitted from the second job processing apparatus and the receipt history stored in the receipt history storage, and wherein the second job processing apparatus comprises a transmission history receiver for receiving the transmission history from the portable terminal apparatus, and a transmitter for transmitting the received transmission history to the first job processing apparatus.

In this system, the transmission history of the job is stored in the portable terminal apparatus, while the received job and the job receipt history are stored in the first job processing apparatus. The job transmission history of the portable terminal apparatus is received by the second job processing apparatus. This transmission history is transmitted to the first job processing apparatus. In the first job processing apparatus, the transmission history received from the second job processing apparatus and the receipt history stored in the first job processing apparatus itself are collated to identify the job corresponding to the transmission history of the portable terminal apparatus among the jobs stored in the job storage. Accordingly, the job corresponding to the transmission history can be assuredly identified.

It can be configured such that the second job processing apparatus identifies the first job processing apparatus by obtaining an address of the job processing apparatus to which the job was transmitted based on the transmission history from the portable terminal apparatus. In this case, the second job processing apparatus identifies the first job processing apparatus by obtaining the address of the job processing apparatus to which the job was transmitted based on the received transmission history. Therefore, the first job processing apparatus can be easily identified, and the transmission history can be transmitted to the identified first job processing apparatus.

Furthermore, it can be configured such that the first job processing apparatus discriminates whether there exists a consistent job in which user information included in the transmission history and user information included in the receipt history coincide, and collates the transmission history and the receipt history only if there exists the consistent job. With this, the security to each job can be strengthened.

Furthermore, it can be configured such that the transmission history includes at least a user name who transmitted the job and a job transmission time, and the receipt history includes at least a user name who transmitted the job and a job receipt time, and wherein the first job processing apparatus identifies a job by collating the user names of both the histories, the job transmission time and the job receipt time. With this, the job identification can be performed with a high degree of accuracy.

Furthermore, it can be configured such that the second job processing apparatus is equipped with a job executor for executing a job identified by the first job processing apparatus. With this, the job received by the first job processing apparatus can be executed by the second job processing apparatus.

Furthermore, it can be configured such that an instruction given on a job to be received by the job receiver and document data as an object of the job are transmitted from the portable terminal apparatus to the first job processing apparatus. With this, the identification of the job in which the job instruction and the document data as an object of the job are transmitted from the portable terminal apparatus to the first job processing apparatus, can be performed with a high degree of accuracy.

Furthermore, it can be configured such that an instruction given on a job to be received by the job receiver is transmitted from the portable terminal apparatus to the first job processing apparatus, and document data as an object of the job is transmitted from an external device other than the portable terminal apparatus to the first job processing apparatus. With this, the identification of the job in which the job instructing is a job transmitted from the portable terminal apparatus to the first job processing apparatus and the document data as an object of the job is transmitted from an external device other than the portable terminal apparatus to the first job processing apparatus, can be performed with a high degree of accuracy.

A job processing system according to these embodiments, which is equipped with a portable terminal apparatus, a first job processing apparatus and a second job processing apparatus, can be configured such that the portable terminal apparatus comprises a transmission history storage for storing a transmission history of a job transmitted to the job processing apparatus, and a transmitter for transmitting the stored transmission history to the job processing apparatus, and the first job processing apparatus comprises a job receiver for receiving a job, a job storage for storing the received job, a receipt history storage for storing a receipt history of the received job, and a transmitter for transmitting the receipt history stored in the receipt history storage to the second job processing apparatus, and the second job processing apparatus comprises a transmission history receiver for receiving the transmission history transmitted from the portable terminal apparatus, a receipt history receiver for receiving the receipt history transmitted from the first job processing apparatus, and a history collator for identifying a job corresponding to the transmission history of the portable terminal apparatus among jobs stored in the job storage by collating the transmission history from the portable terminal apparatus and the receipt history from the first job processing apparatus.

In this system, the job transmission history is stored in the portable terminal apparatus, while the received job and the job receipt history are stored in the first job processing apparatus. The job transmission history of the portable terminal apparatus is transmitted to the second job processing apparatus and the receipt history is transmitted from the first job processing apparatus to the second job processing apparatus. In the second job processing apparatus, the transmission history and the receipt history are collated to identify the job corresponding to the transmission history of the portable terminal apparatus among the jobs stored in the job storage. Accordingly, the job corresponding to the transmission history can be assuredly identified.

It can be configured such that the second job processing apparatus identifies the first job processing apparatus by obtaining an address of the first job processing apparatus to which the job was transmitted based on the transmission history from the portable terminal apparatus. In this case, the second job processing apparatus identifies the first job processing apparatus by obtaining the address of the job processing apparatus to which the job was transmitted based on the received transmission history. Therefore, the first job processing apparatus can be easily identified.

Furthermore, it can be configured such that the second job processing apparatus discriminates whether there exists a job in which user information included in the transmission history and user information included in the receipt history coincide, and collates the transmission history and the receipt history only if there exists a consistent job. With this, the security to each job can be strengthened.

Furthermore, it can be configured such that the transmission history includes at least a user name who transmitted the job and a job transmission time, and the receipt history includes at least a user name who transmitted the job and a job receipt time, and wherein the second job processing apparatus identifies a job by collating the user names of both the histories, the job transmission time and the job receipt time. With this, the identification of the job can be performed with a high degree of accuracy.

Furthermore, it can be configured such that the second job processing apparatus is equipped with a job executor for executing an identified job. In this case, the job received by the first job processing apparatus can be executed by the second job processing apparatus.

Furthermore, it can be configured such that an instruction given on a job to be received by the job receiver and document data as an object of the job are transmitted from the portable terminal apparatus to the first job processing apparatus. With this, the identification of the job in which the job instruction and the document data as an object of the job are transmitted from the portable terminal apparatus to the first job processing apparatus, can be performed with a high degree of accuracy.

Furthermore, it can be configured such that an instruction given on a job to be received by the job receiver is transmitted from the portable terminal apparatus to the first job processing apparatus and document data as an object of the job is transmitted from an external device other than the portable terminal apparatus to the first job processing apparatus. In this case, the identification of the job in which the job instruction was transmitted from the portable terminal apparatus to the first job processing apparatus and the document data as an object of the job was transmitted from an external device other than the personal terminal apparatus to the first job processing apparatus, can be performed with a high degree of accuracy.

A job processing apparatus according to these embodiments can be configured to comprise a job receiver for receiving a job, a job storage for storing the received job, a receipt history storage for storing a receipt history of the received job, a transmission history receiver for receiving a job transmission history stored in the portable terminal apparatus, and a history collator for identifying a job corresponding to the transmission history of the portable terminal apparatus among jobs stored in the job storage by collating the transmission history received by the transmission history receiver and the receipt history stored in the receipt history storage.

In this job processing apparatus, the received job and the job receipt history are stored. The job transmission history of the portable terminal apparatus is received by the job processing apparatus, and the transmission history and the receipt history are collated to thereby identify the job corresponding to the transmission history of the portable terminal apparatus among the jobs stored in the job storage. Accordingly, the job corresponding to the transmission history can be assuredly identified.

It can be configured such that the history collator discriminates whether there exists a job in which user information included in the transmission history and user information included in the receipt history coincide, and collates the transmission history and the receipt history only if there exists a consistent job. With this, the security to each job can be strengthened.

Furthermore, it can be configured such that the transmission history includes at least a user name who transmitted the job and a job transmission time and the receipt history includes at least a user name who transmitted the job and a job receipt time, and wherein the history collator identifies a job by collating the user names of both the histories, the job transmission time and the job receipt time. This enables the job identification with a high degree of accuracy.

Furthermore, it can be configured such an instruction given on a job to be received by the job receiver and document data as an object of the job are transmitted from the portable terminal apparatus. The identification of the job in which the job instruction and the document data as an object of the job were transmitted from the portable terminal apparatus, can be performed with a high degree of accuracy.

Furthermore, it can be configured such that an instruction given on a job to be received by the job receiver is transmitted from the portable terminal apparatus, and document data as an object of the job is transmitted from an external device other than the portable terminal apparatus. In this case, the identification of the job in which the job instruction was transmitted from the portable terminal apparatus and the document data as an object of the job was transmitted from an external device other than the personal terminal apparatus, can be performed with a high degree of accuracy.

A job identifying method according to these embodiments comprises a step of receiving a job, a step of storing the received job, a step of storing a receipt history of the received job, a step of receiving a transmission history of a job stored in a portable terminal apparatus, and a step of identifying a job corresponding to the transmission history of the portable terminal apparatus among the stored jobs by collating the received transmission history and the stored receipt history. In this case, the job corresponding to the transmission history can be assuredly identified by collating the job transmission history of the portable terminal apparatus and the receipt history of the received job.

A job identifying processing program according to these embodiments makes a computer execute a step of receiving a job, a step of storing the received job, a step of storing a receipt history of the received job, a step of receiving a transmission history of a job stored in a portable terminal apparatus, and a step of identifying a job corresponding to the transmission history of the portable terminal apparatus among the stored jobs by collating the received transmission history and the stored receipt history. This enables a computer to execute processing to assuredly identify a job corresponding to the transmission history.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims an not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A job processing system equipped with a portable terminal apparatus and a job processing apparatus,
wherein the portable terminal apparatus comprises:
a transmission history storage that stores a transmission history of a job transmitted to the job processing apparatus; and
a transmitter that transmits the stored transmission history to the job processing apparatus, and
wherein the job processing apparatus comprises:
a job receiver that receives the job;
a job storage that stores the received job;
a receipt history storage that stores a receipt history of the received job;
a transmission history receiver that receives the transmission history from the portable terminal apparatus; and
a history collator that identifies a job corresponding to the transmission history of the portable terminal apparatus among jobs stored in the job storage by collating the transmission history received by the transmission history receiver and the receipt history stored in the receipt history storage.

2. The job processing system as recited in claim 1, wherein the job processing apparatus discriminates whether there exists a consistent job in which user information included in the transmission history and user information included in the receipt history coincide, and performs a collation of the transmission history and the receipt history only if there exists the consistent job.

3. The job processing system as recited in claim 1, wherein the transmission history includes at least a user name who transmitted the job and a job transmission time and the receipt history includes at least a user name who transmitted the job and a job receipt time, and wherein the history collator identifies a job by collating the user names of both the histories, the job transmission time and the job receipt time.

4. The job processing system as recited in claim 1, wherein an instruction given on a job to be received by the job receiver and document data as an object of the job are transmitted from the portable terminal apparatus to the job processing apparatus.

5. The job processing system as recited in claim 1, wherein an instruction given on a job to be received by the job receiver is transmitted from the portable terminal apparatus to the job processing apparatus and document data as an object of the job is transmitted from an external device other than the portable terminal apparatus to the job processing apparatus.

6. A job processing system equipped with a portable terminal apparatus, a first job processing apparatus and a second job processing apparatus,
wherein the portable terminal apparatus comprises:
a transmission history storage that stores a transmission history of a job transmitted to the job processing apparatus; and
a transmitter that transmits the stored transmission history to the job processing apparatus, and
wherein the first job processing apparatus comprises:
a job receiver that receives the job;
a job storage that stores the received job;
a receipt history storage that stores a receipt history of the received job; and
a history collator that identifies the job corresponding to the transmission history of the portable terminal apparatus among jobs stored in the job storage by collating the transmission history of the portable terminal apparatus transmitted from the second job processing apparatus and the receipt history stored in the receipt history storage, and
wherein the second job processing apparatus comprises:
a transmission history receiver that receives the transmission history from the portable terminal apparatus; and
a transmitter that transmits the received transmission history to the first job processing apparatus.

7. The job processing system as recited in claim 6, wherein the second job processing apparatus identifies the first job processing apparatus by obtaining an address of the job processing apparatus to which the job was transmitted based on the transmission history from the portable terminal apparatus.

8. The job processing system as recited in claim 6, wherein the first job processing apparatus discriminates whether there exists a consistent job in which user information included in the transmission history and user information included in the receipt history coincide, and collates the transmission history and the receipt history only if there exists the consistent job.

9. The job processing system as recited in claim 6, wherein the transmission history includes at least a user name who transmitted the job and a job transmission time and the receipt history includes at least a user name who transmitted the job and a job receipt time, and wherein the first job processing apparatus identifies a job by collating the user names of both the histories, the job transmission time and the job receipt time.

10. The job processing system as recited in claim 6, wherein the second job processing apparatus is equipped with a job executor for executing a job specified by the first job processing apparatus.

11. The job processing system as recited in claim 6, wherein an instruction given on a job to be received by the job receiver and document data as an object of the job are transmitted from the portable terminal apparatus to the first job processing apparatus.

12. The job processing system as recited in claim 6, wherein an instruction given on a job to be received by the job receiver is transmitted from the portable terminal apparatus to the first job processing apparatus and document data as an object of the job is transmitted from an external device other than the portable terminal apparatus to the first job processing apparatus.

13. A job processing system equipped with a portable terminal apparatus, a first job processing apparatus and a second job processing apparatus,
wherein the portable terminal apparatus comprises:
a transmission history storage that stores a transmission history of a job transmitted to the job processing apparatus; and
a transmitter that transmits the stored transmission history to the job processing apparatus, and
wherein the first job processing apparatus comprises:
a job receiver that receives a job;
a job storage that stores the received job;
a receipt history storage that stores a receipt history of the received job; and
a transmitter that transmits the receipt history stored in the receipt history storage to the second job processing apparatus, and
wherein the second job processing apparatus comprises:
a transmission history receiver that receives the transmission history transmitted from the portable terminal apparatus;
a receipt history receiver that receives the receipt history transmitted from the first job processing apparatus; and
a history collator that identifies a job corresponding to the transmission history of the portable terminal apparatus among jobs stored in the job storage by collating the transmission history from the portable terminal apparatus and the receipt history from the first job processing apparatus.

14. The job processing system as recited in claim 13, wherein the second job processing apparatus identifies the first job processing apparatus by obtaining an address of the first job processing apparatus to which the job was transmitted based on the transmission history from the portable terminal apparatus.

15. The job processing system as recited in claim 13, wherein the second job processing apparatus discriminates whether there exists a consistent job in which user information included in the transmission history and user information included in the receipt history coincide, and collates the transmission history and the receipt history only if there exists the consistent job.

16. The job processing system as recited in claim 13, wherein the transmission history includes at least a user name who transmitted the job and a job transmission time and the receipt history includes at least a user name who transmitted the job and a job receipt time, and wherein the second job processing apparatus identifies a job by collating the user names of both the histories, the job transmission time and the job receipt time.

17. The job processing system as recited in claim 13, wherein the second job processing apparatus is equipped with a job executor for executing an identified job.

18. The job processing system as recited in claim 13, wherein an instruction given on a job to be received by the job receiver and document data as an object of the job are transmitted from the portable terminal apparatus to the first job processing apparatus.

19. The job processing system as recited in claim 13, wherein an instruction given on a job to be received by the job receiver is transmitted from the portable terminal apparatus to the first job processing apparatus and document data as an object of the job is transmitted from an external device other than the portable terminal apparatus to the first job processing apparatus.

20. A job processing apparatus comprising:
a job receiver that receives a job;
a job storage that stores the received job;
a receipt history storage that stores a receipt history of the received job;
a transmission history receiver that receives a job transmission history stored in the portable terminal apparatus; and
a history collator that identifies a job corresponding to the transmission history of the portable terminal apparatus among jobs stored in the job storage by collating the transmission history received by the transmission history receiver and the receipt history stored in the receipt history storage.

21. The job processing apparatus as recited in claim 20, wherein the history collator discriminates whether there exists a job in which user information included in the transmission history and user information included in the receipt history coincide, and collates the transmission history and the receipt history only if there exists a consistent job.

22. The job processing apparatus as recited in claim 20, wherein the transmission history includes at least a user name who transmitted the job and a job transmission time and the receipt history includes at least a user name who transmitted the job and a job receipt time, and wherein the history collator identifies a job by collating the user names of both the histories, the job transmission time and the job receipt time.

23. The job processing apparatus as recited in claim 20, wherein an instruction given on a job to be received by the job receiver and document data as an object of the job are transmitted from the portable terminal apparatus.

24. The job processing apparatus as recited in claim 20, wherein an instruction given on a job to be received by the job receiver is transmitted from the portable terminal apparatus and document data as an object of the job is transmitted from an external device other than the portable terminal apparatus.

25. A job identifying method comprising:
a step of receiving a job;
a step of storing the received job;
a step of storing a receipt history of the received job;
a step of receiving a transmission history of a job stored in a portable terminal apparatus; and
a step of identifying a job corresponding to the transmission history of the portable terminal apparatus among the stored jobs by collating the received transmission history and the stored receipt history.

26. A computer readable recording medium storing a job identifying processing program therein to make a computer execute:
a step of receiving a job;
a step of storing the received job;
a step of storing a receipt history of the received job;
a step of receiving a transmission history of a job stored in a portable terminal apparatus; and
a step of identifying a job corresponding to the transmission history of the portable terminal apparatus among the stored jobs by collating the received transmission history and the stored receipt history.
